(19) United States
(12) Patent Application Publication
(10) Pub. No.: US 2007/0133695 A1
(43) Pub. Date: Jun. 14, 2007

(54) Method and system for channel assignment of OFDM channels

(76) Inventor: Michael D. Kotzin, Buffalo Grove, IL (US)

Correspondence Address: MOTOROLA, INC., 1303 EAST ALGONQUIN ROAD, IL01/3RD, SCHAUMBURG, IL, 60196, US

(21) Appl. No.: 11/297,950

(22) Filed: Dec. 9, 2005

(51) Int. Cl. H04K 1/10

(52) U.S. Cl. 375/260

(57) ABSTRACT

A method and system for assigning a carrier channel to a subscriber device (102) in an OFDM system is provided. The method includes estimating (602) a link impairment associated with the subscriber device. The method also includes assigning (604) the subscriber device to a carrier channel having a cyclic prefix that conforms to the link impairment. The link impairment is related to the delay spread of a link used by the subscriber device.

### RELATED APPLICATION

This application is related to U.S. patent application Ser. No. 11/052,700, entitled “Variable Cyclic Prefix in Mixed-Mode Wireless Communication Systems”, filed on Feb. 7, 2005, and assigned to the assignee hereof.

### FIELD OF THE INVENTION

The present invention relates in general to Orthogonal Frequency Divisional Multiplexed (OFDM) systems, and more specifically, to channel assignment of a signal in an OFDM system.

### BACKGROUND OF THE INVENTION

An Orthogonal Frequency Divisional Multiplexed (OFDM) system is a communication system that employs multi-carriers or multiple carrier radio channels. A problem faced by OFDM systems is that a transmitted signal can arrive at a destination via multiple paths, which results in a delay spread of the signal. The delay spread is a type of distortion that occurs due to the multiple paths taken by the signal, and results in the spreading out or ‘smearing’ of the signal at a receiver end. In order to offset the effect of the delay spread, OFDM systems employ cyclic prefixes which serve as a guard time between successive transmitted symbols. In conventional OFDM systems, the length of the cyclic prefix is designed to be equal to or greater than the length of the delay spread; therefore the smearing of the signal only extends into the guard time. In this way, a cyclic prefix eliminates intersymbol interference.

The cyclic prefix signal is constructed to further eliminate intrasymbol interference and permit the use of simplified receivers. By using a cyclic prefix waveform that is a replica of the last part of the symbol, it is possible to make the transmitted symbol look periodic in time.

The cyclic prefix is redundant, unused information that is attached to the signal to be transmitted and conveys no useful information. It is therefore desirable to minimize the length of the cyclic prefix employed whenever possible.

In a traditional OFDM system, all the channels have the same cyclic prefix. Hence, in order to accommodate all the users, the length of a chosen cyclic prefix covers all contingencies. Therefore, all the subscribers of the system are assigned the chosen cyclic prefix.

As stated above, the use of the cyclic prefix in the OFDM system results in the transmission of redundant information. Although the use of the cyclic prefix reduces receiver complexity and improves performance, it also reduces the system capacity by consuming bandwidth and energy to transmit redundant data.

### BRIEF DESCRIPTION OF THE DRAWINGS

In the accompanying figures, like reference numerals refer to identical or functionally similar elements throughout the separate views. These, together with the detailed description below, are incorporated in and form part of the specification, and serve to further illustrate the embodiments and explain various principles and advantages, in accordance with the present invention.

FIG. 1 illustrates an environment in which various embodiments of the present invention can be practiced;

FIG. 2 illustrates a block diagram of a base transceiver station, in accordance with an embodiment of the present invention;

FIG. 3 is an exemplary block diagram of a system assigning a subscriber device to a particular carrier channel, in accordance with an embodiment of the present invention;

FIG. 4 is an exemplary block diagram of a monitoring module, in accordance with an embodiment of the present invention;

FIG. 5 is an exemplary block diagram of an assignment module, in accordance with an embodiment of the present invention;

FIG. 6 is an exemplary flowchart illustrating a method for assigning a subscriber device to communicate on a carrier channel, in accordance with an embodiment of the present invention;

FIG. 7 is an exemplary flowchart illustrating a method for balancing a load on carrier channels, in accordance with an embodiment of the present invention; and

FIG. 8 is an exemplary flowchart illustrating a method for a subscriber device to make a request for a new carrier channel.

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of embodiments of the present invention.

### DETAILED DESCRIPTION OF THE INVENTION

Before describing in detail the particular method and system for channel assignment of Orthogonal Frequency Divisional Multiplexed (OFDM) channels in accordance with the present invention, it should be observed that the present invention resides primarily in combinations of method steps and system components related to channel assignment of OFDM channels. Accordingly, the system components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The present invention describes a method for assigning a carrier channel for communicating information to a subscriber device. The method includes determining a characteristic of the received signal from the subscriber device. The method also includes assigning the subscriber device to communicate on a carrier channel (which may be alternatively worded as assigning the subscriber device to a carrier channel) that employs a cyclic prefix conforming to the determined characteristic.

The present invention further describes a method used in a subscriber device. The method includes determining whether a cyclic prefix employed by a carrier channel, to which a transmission of the subscriber device is assigned, conforms to a characteristic of the transmission. The method also includes a request for re-assignment to a carrier channel employing a cyclic prefix that conforms to the characteristic.

Moreover, the present invention describes a system for assigning a channel for communicating information to and from a subscriber device. The system includes a monitoring module and an assignment module. The monitoring module determines a link impairment associated with the subscriber device. The assignment module assigns the subscriber device to transmit a carrier channel that employs a cyclic prefix conforming to the link impairment.

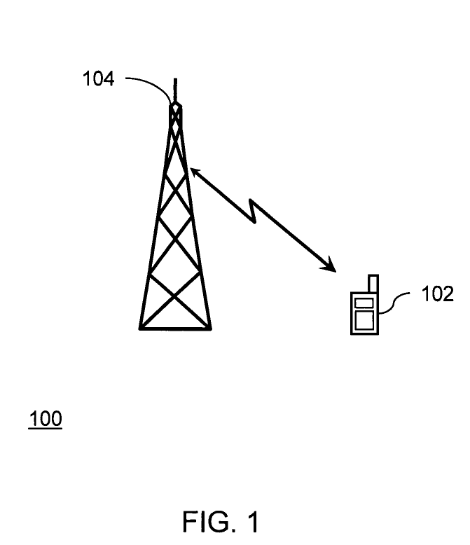

FIG. 1 illustrates an environment in which various embodiments of the present invention can be practiced. The environment includes an OFDM radio communication system, which includes multiple OFDM carrier channels. Each carrier channel conveys transmissions. A Base Transceiver Station (BTS) 104 receives a transmission from a subscriber device 102. A transmission can also be made by the BTS 104 and received by the subscriber device 102.

As is known in the art, such radio communication systems may be operated in one of two modes. In a time division multiplexed (TDM) mode, the transmissions from the BTS 104 to the subscriber device 102 are made on the same radio channel frequency as the transmissions from the subscriber device 102 to the BTS 104. Non-overlapping periods of time are alternately used by the BTS 104 and the subscriber. In this TDM mode, the BTS 104 and subscriber device 102 each receive only a fraction of the time for transmission. In a frequency division multiplexed (FDM) mode, the transmissions from the BTS 104 to the subscriber device 102 are made on one radio channel frequency and the transmissions from the subscriber device 102 to the BTS 104 are made on another. Since the two frequencies are different the BTS 104 and subscriber device 102 have full utilization of the radio channel frequency. In the latter FDM case, the two frequencies are typically paired, with the up- and down-link channels a fixed offset apart. For the remainder of this application, the term “carrier channel” corresponds to either the single frequency used in a system employing the TDM mode or one of the channel pair as used in a system employing the FDM mode.

The subscriber device 102 of the OFDM system is assigned to a particular carrier channel in the OFDM system. The channel is used to receive signals by the subscriber device 102 from a BTS 104 and may also be used to transmit signals to the BTS 104. However, since each signal propagates via multiple paths, there is a need to offset the impairments caused by delay spread of the transmission. In order to do this, the subscriber device 102 appends a cyclic prefix to the transmission that conforms to the cyclic prefix employed for the particular carrier channel.

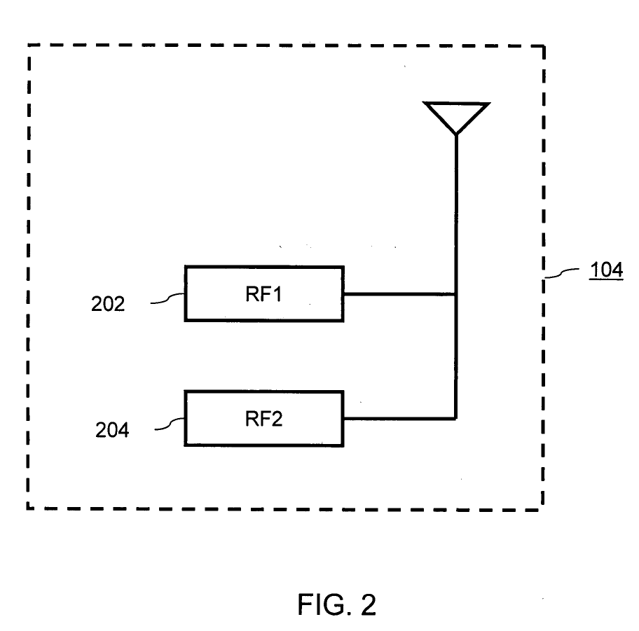

FIG. 2 illustrates a block diagram of the BTS 104, in accordance with some embodiments of the present invention. For exemplary purposes, the BTS 104 is shown with transceivers which utilize two carrier channels, RF1 202 and RF2 204. RF1 202 is a carrier channel with a first frequency (or frequency pair for an FDM type system), which receives transmissions having a cyclic prefix of a first predetermined length. RF2 204 is a carrier channel with a second frequency, which receives transmissions having a cyclic prefix of a second predetermined length. In this manner, the BTS 104 utilizes the multiple carrier channels that employ cyclic prefixes of different lengths. The BTS 104 may receive transmissions on other carrier channels, each of which may employ one of the first or second cyclic prefixes, or which may employ one of a set of other cyclic prefixes. The BTS 104 therefore uses carrier channels to receive transmissions that employ at least two distinct cyclic prefixes. In one embodiment of the present invention, each of the carrier channels included in the OFDM system receives transmissions employing designated cyclic prefixes that are all different. That a carrier channel only receives transmissions having a designated cyclic prefix is alternatively described herein as a carrier channel employing a designated cyclic prefix. In another embodiment of the present invention, some of the carrier channels included in the OFDM system employ the same cyclic prefix for receiving transmissions. The BTS 104 maintains a list of a set of the cyclic prefixes. In one embodiment of the present invention, the set of the cyclic prefixes includes all the cyclic prefixes used by the carrier channels that are used by the BTS 104 for receiving transmissions. In an alternate embodiment of the present invention, the list does not include the cyclic prefixes of the carrier channels that are fully or completely occupied. In one embodiment of the present invention, the list is made available to the subscriber device 102.

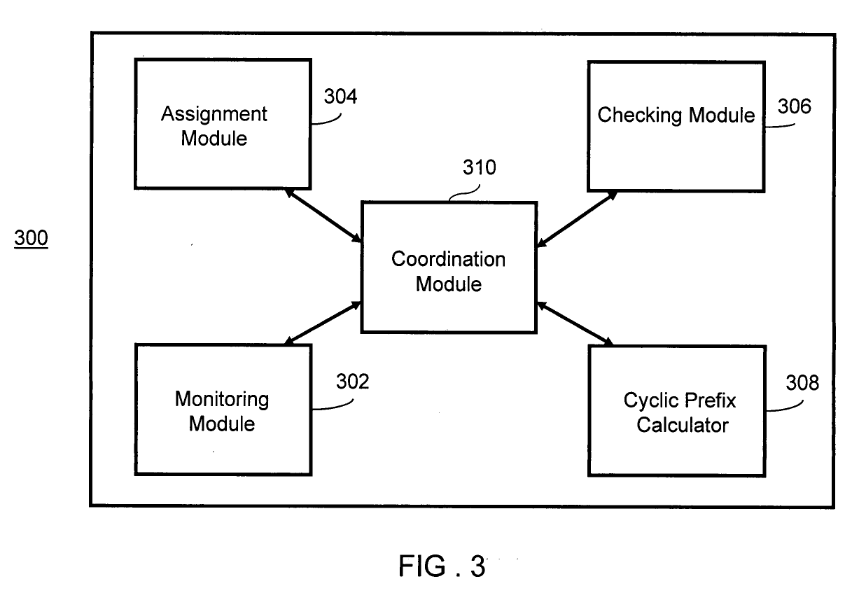

FIG. 3 is an exemplary block diagram of a system 300, which assigns a subscriber device 102 to a particular carrier channel, in accordance with some embodiments of the present invention. For proper system operation, subscriber devices 102 which utilize a particular radio channel for transmissions must employ the particular length of cyclic prefix associated with that particular radio channel. The system 300 may include a monitoring module 302, an assignment module 304, a checking module 306, a cyclic prefix calculator 308, and a coordination module 310. Different embodiments, may have some (or all) of these modules 302, 304, 306, 308 resident in a fixed network portion of a radio communication system, such as a BTS 104 of an OFDM communication system with others (or all) of the modules 302, 304, 306, 308 resident in a subscriber device 102. The monitoring module 302 is capable of determining a link impairment from at least one link parameter associated with subscriber device 102. In other words, the monitoring module 302 is able to determine at least one parameter from which the nature of signal impairments that have occurred as the signal propagated from the subscriber device 102 to the BTS 104 can be estimated. Generally speaking, these impairments will be estimated as one impairment value that is related to the amount or duration of the differential delay (multipath) that the signal experienced during the transmission. The monitoring module 302, the link impairment, and the link parameters will be further explained in more detail below. The monitoring module 302 passes on information regarding the link impairment associated with the subscriber device 102 to the assignment module 304. The assignment module 304 is capable of assigning the subscriber device 102 to the carrier channel that employs the cyclic prefix, which conforms to the link impairment. The assignment of the subscriber device 102 may be made by sending signaling from the BTS 104 to the subscriber device 102 which includes commands that cause the subscriber device 102 to use a particular carrier channel, or to change to a new cyclic prefix on an already assigned channel. Such assignments are made as necessary from time to time to keep the subscriber device 102 using a carrier channel having an appropriate cyclic prefix. The cyclic prefix which conforms to the link impairment will be long enough to ensure that a receiver of the transmission will be able to compensate for any detrimental effects from multipath fading. The checking module 306 and the cyclic prefix calculator 308 balance the load on the carrier channels.

The checking module 306 periodically checks the load, or number of subscriber device assignments, on a plurality of carrier channels of the system 300. The cyclic prefix calculator 308 calculates the lengths of the cyclic prefixes that will be employed by the plurality of carrier channels. The coordination module 310 coordinates the activities between all the above stated modules to ensure that cyclic prefix selections associated with the overall carrier channels in use by the systems properly accommodate all the subscribers in the system in an optimum way. This includes making sure that the set of cyclic prefixes associated with carrier channels are adequate to meet the needs of all the subscribers with which the BTS 104 is in communication. In one embodiment of the present invention, the system 300 comprises an electronic device that operates in a communication network. The electronic device is capable of performing all the tasks of the modules mentioned above. In another embodiment of the present invention, the system 300 comprises multiple electronic devices operating in the communication network, with the functionality of each module being provided by combining the functionalities of the multiple electronic devices. The system 300 can reside on the BTS 104 or on the subscriber device 102, or in a combination thereof.

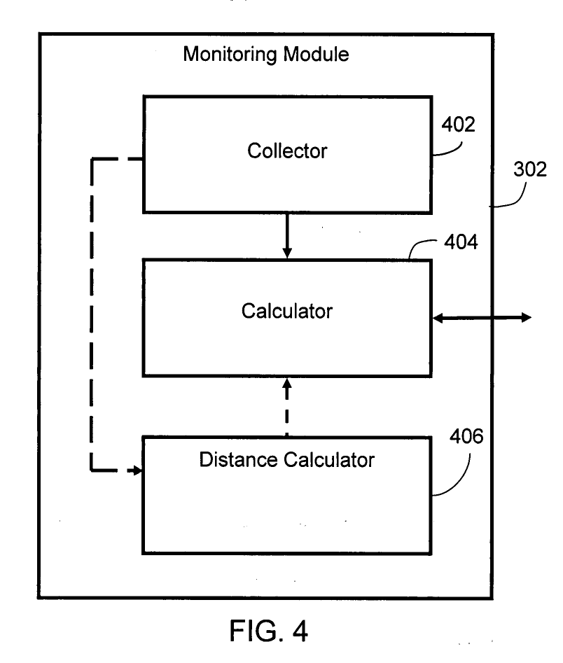

FIG. 4 is an exemplary block diagram of the monitoring module 302, in accordance with some embodiments of the present invention. The monitoring module may include a collector 402, a calculator 404, and a distance calculator 406. The collector 402 collects information pertaining to the affect the signal paths have on signals transmission by and/or received by the subscriber device 102, i.e. the link impairment. The information collected by the collector 402 may include, but is not limited to, direct measurements of a delay spread, link parameters such as transmission signal strength and information relating to the environment of the subscriber device 102. The direct measurements of the delay spread are performed on a received signal by known methods, such as those based on determined matched filter coefficients, equalizer tap coefficients, etc. (When the collector 402 is a component of the subscriber device 102, the signal from which the delay spread is measured is one that is being transmitted by a BTS 104. When the collector 402 is a component of the BTS 104, the signal is one being transmitted by the subscriber device 102.) The information relating to the environment of the subscriber device 102 may include link parameters regarding whether the subscriber device 102 is indoors or outdoors, or whether the subscriber device 102 is presently located in a high latency environment, which refers to an environment where time between transmission and reception of a signal is high. These link parameters can provide implicit information to aid in the decision process of which carrier channel to assign to a particular subscriber device. The collector 402 provides this information to the calculator 404. The calculator 404 uses the information received from the collector 402 to estimate a link impairment associated with the subscriber device 102. The link impairment estimated by the calculator 404 may be a delay spread characteristic of the radio frequency link between the subscriber device 102 and a BTS 104 with which it is linked. In one embodiment of the present invention, the collector 402 provides the information to the distance calculator 406. The distance calculator 406 uses the information received from the collector 402 to determine the distance between the subscriber device 102 and the BTS 104, which may further be used in the link impairment estimation process.

Overall, it is the determination of the multipath affects associated with a received subscriber device signal combined with the additional information related to such things as subscriber location and environment which allows the monitoring module to determine a [minimum] length of the necessary cyclic prefix length that is best for the subscriber device 102 to be assigned for communications.

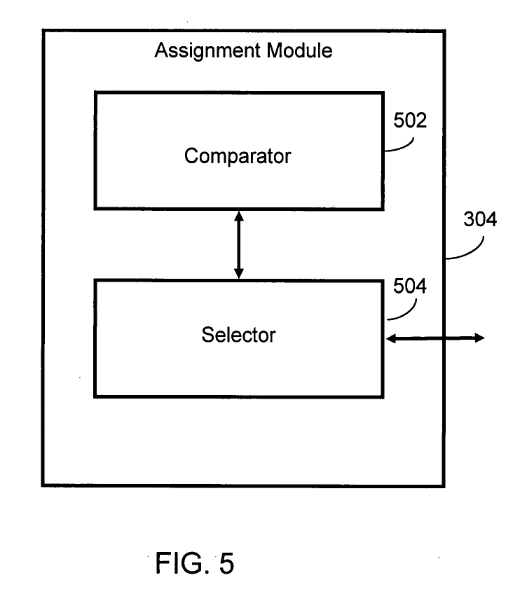

FIG. 5 is an exemplary block diagram of the assignment module 304, in accordance with some embodiments of the present invention. The assignment module 304 may include a comparator 502 and a selector 504. The comparator 502 compares a duration value of the estimated link impairment with durations of the set of cyclic prefixes currently in use for the carrier channels. In one embodiment of the present invention, the duration of a link impairment is compared with a duration of each of a set of cyclic prefixes. This is alternatively stated more simply as “comparing the link impairment to a set of cyclic prefixes”. The comparator 502, after the comparison, divides the set of cyclic prefixes into two sets. The cyclic prefixes in the first set of cyclic prefixes are shorter than the link impairment associated with the subscriber device. Therefore, the first set of cyclic prefixes includes those cyclic prefixes that cannot satisfy the requirements for reliable transmissions to and from the subscriber device. The second set of cyclic prefixes includes the cyclic prefixes that are equal to or longer than the ones required for reliable transmission to and from the subscriber device 102. The comparator 502 then eliminates the first set of cyclic prefixes. Hence, the comparator 502 eliminates all the carrier channels that employ the cyclic prefixes that are shorter than the ones required for reliable transmissions. The result of this elimination is that the assignment module 304 now selects the cyclic prefix to be employed by the carrier channel from the second set of cyclic prefixes. The selector 504 selects the carrier channel that employs the cyclic prefix from the second set of cyclic prefixes. The cyclic prefix employed by the carrier channel selected by the selector 504 has the shortest length in the second set. In other words, the carrier channel employing the cyclic prefix with the shortest length in the second set is selected as the carrier channel to which the communication is assigned. In other embodiments the same operation is performed by the assignment module 304, but the link parameter is a distance related characteristic that is first converted to a time characteristic by a relationship such as ds=a*d, wherein ds is a delay spread estimate, a is a delay rate in microseconds per kilometer, and d is a distance in kilometers. Of course, such a conversion could be performed by the calculator module 404, so that the link impairment is determined as a delay spread characteristic from the distance related information. It is important to realize that a determination such as this is based on the empirical observation that the further a subscriber device 102 is from the BTS 104, the higher the differential delay that is likely to be associated with the received signal. The required length of the cyclic prefix is not directly related to the signal's propagation delay from the subscriber device 102 to the BTS 104, but rather the differential delays that are incurred due to such things as signal reflections off buildings, hills, mountains, etc. The factor, a, that is used in the equation above is usually empirically derived based on previously made measurements.

It is further understood that there is a need for transmissions from both the subscriber device 102 and the BTS 104 to include cyclic prefixes to accommodate differential time delays that will be imparted to the propagated transmissions. Typically, the cyclic prefixes for the subscriber device 102 transmission and the BTS transmission can be of the same value. This is due to the more or less reciprocal propagation paths in the two directions between the subscriber device 102 and the BTS 104. This equality in cyclic prefix length, however, is not a requirement of this invention. Based on the disclosed information herein, it would be apparent to one skilled in the art to configure and operate a system where the lengths of the cyclic prefixes for the uplink and downlink—even for the same carrier channel—are not the same. It should also be recognized that the estimation of the link impairment—e.g. the amount of multipath present on a received signal—can be accomplished at either the BTS 104 or the subscriber device 102 and may be based on one or more link parameters, each of which may be determined at either the BTS 104 or the subscriber device 102. In some embodiments in which the link impairment is estimated based on at least one link parameter determined at the subscriber device 102, signaling protocols would be provided so that the subscriber device 102 could send the link parameter determinations to the BTS 104, where channel assignments are traditionally (but not necessarily) made. Signaling from the subscriber to the BTS may also be provided for other useful information. Link parameters, such as subscriber device location and environment, which would aid the BTS's final determination process of the necessary length of cyclic prefix, could be provided in the transmissions form the subscriber device.

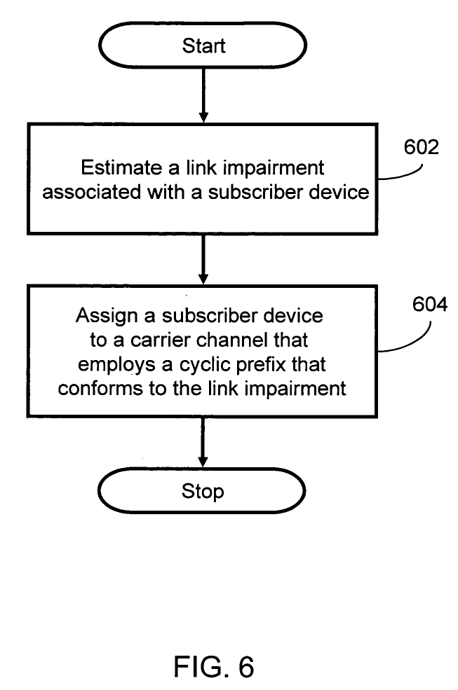

FIG. 6 is an exemplary flowchart illustrating a method for assigning a subscriber device to the carrier channel, in accordance with some embodiments of the present invention. At step 602, a link impairment associated with the subscriber device 102 is determined. This link impairment reflects the cyclic prefix requirement of the transmission. In some embodiments of the present invention, the link impairment is closely related to a delay spread of the link used to convey communications to and/or from the subscriber device 102. In some embodiments, the link impairment is determined based on a direct measurement of the delay spread of a signal propagated over the link to a receiver that may be in the subscriber device or in a fixed network device (BTS 104) In other embodiments of the present invention, the link impairment is implicitly determined, for example, based on the distance between the subscriber device 102 and the BTS 104. An exemplary method for estimating the distance between the subscriber device 102 and the BTS 104 is to measure the signal strength at the subscriber device 102. A strong signal at the subscriber device 102 signifies a smaller distance between the subscriber device 102 and the BTS 104 than a weak signal. In one embodiment of the present invention, one or more link parameters are determined by the subscriber device 102. For some of these embodiments, the subscriber device 102 provides parameters that are measurements of its environment to the BTS 104. The measurement of the environment of the subscriber device 102 may include information relating to whether the subscriber device 102 is indoors or outdoors, or whether it is currently located in a highly time-dispersive propagation environment. In another embodiment of the present invention, one or more of the link parameters are determined by the BTS 104. For some embodiments, the link impairment is estimated based on a combination of link parameters, such as direct measurements of a delay spread of each of one or more signals, type of environment and/or distance. These parameters may be combined using methods known in the art, such as by weighting the parameters.

At step 604, the subscriber device 102 is assigned to the carrier channel that has a cyclic prefix that conforms to the link impairment. A method for assigning the subscriber device to the carrier channel will now be discussed. In one embodiment of the present invention, the link impairment is used to determine a suitable cyclic prefix for the transmission, which is compared with the set of cyclic prefixes. The cyclic prefixes that are shorter than the suitable cyclic prefix for the transmission are rejected. Of the cyclic prefixes that remain, the one with the shortest length is selected. The subscriber device 102 is assigned to the carrier channel with the cyclic prefix that is selected. In another embodiment of the present invention, the subscriber device 102 selects the carrier channel that is most suited to it (i.e., the subscriber device assigns itself to the carrier channel and informs the BTS 104 and/or the communication network).

If the link impairment reflects that the cyclic prefix requirement of the transmission is high, then the subscriber device 102 is assigned to the carrier channel that employs a large cyclic prefix. However, if the link impairment reflects that the cyclic prefix requirement of the transmission is low, then the subscriber device 102 is assigned to the carrier channel that employs a small cyclic prefix.

In one embodiment of the present invention, the subscriber device 102 is initially assigned to the carrier channel that employs the largest cyclic prefix, which is able to accommodate transmissions having link impairment values that are predicted as being likely to occur, based on the estimated link impairment and predicted variations of the estimated link impairments. The carrier channel employing the largest cyclic prefix is able to accommodate any expected transmission, irrespective of its link parameters or estimated link impairment.

The user of the subscriber device 102 may be mobile. The link impairment may vary with a change in the location of the user of the subscriber device 102. Various embodiments of the present invention cater to link impairment associated with the subscriber device 102, even when the cyclic prefix requirements of the communications change.

After the subscriber device has been assigned to the carrier channel, the BTS 104 or subscriber device 102 repetitively checks the link parameter or parameters associated with the subscriber device 102. If the BTS 104 determines that a value of the link impairment determined from the one or more link parameters has changed enough to merit a change in the carrier channel, the BTS 104 commands the subscriber device 102 to hand off the transmission to the carrier channel that employs a cyclic prefix which conforms to the changed value of the link impairment. In another embodiment of the present invention, the subscriber device 102 selects the carrier channel that employs the cyclic prefix which conforms to the changed value of the link impairment and requests the BTS 104 or network to be assigned to that carrier channel.

The method described above will now be explained with the help of the following example of some embodiments. Let the exemplary values of the cyclic prefixes employed by the carrier channel RF1 202 and the carrier channel RF2 204 be 20 microseconds and 10 microseconds, respectively. Initially, the subscriber device 102 is assigned to the carrier channel RF1 202. Since the carrier channel RF1 202 has the longest cyclic prefix, the carrier channel RF1 202 will be able to accommodate any transmission of the subscriber device 102 within the given coverage area of the BTS 104. At step 602, the BTS 104 estimates the link impairment. Let the exemplary duration of a suitable cyclic prefix for a transmission having this link impairment be equal to 8 microseconds. At step 604, the BTS 104 will compare the suitable cyclic prefix with the set of cyclic prefixes employed by the carrier channels RF1 202 and RF2 204. The BTS 104 will determine that the carrier channel RF2 204 is more suited for communication with the subscriber device 102 and assign the subscriber device 102 to perform communication using the carrier channel RF2 204.

After the subscriber device has been assigned to transmit on the carrier channel RF2 204, the BTS 104 will repetitively check further communications with the subscriber device 102 for a change in the link parameters that result in a change of the estimated link impairment. If the user of the subscriber device 102 now moves closer to the BTS 104, this results in a change in the estimated value of the link impairment, and therefore, a change in the suitable cyclic prefix for communications, such as from 8 microseconds to 5 microseconds. Since the change in the suitable cyclic prefix of the communication does not merit a change in the carrier channel, the BTS 104 will allow the communication to be performed on the carrier channel RF2 204. If the user of the subscriber device 102 moves away from the BTS 104, this results in a change in the value of the suitable cyclic prefix for the communication, such as from 5 microseconds to 9 microseconds. Since this increasing change in the suitable cyclic prefix is nearing that of the threshold value of 10 microseconds, the communication merits a change of the carrier channel, and the BTS 104 will assign the subscriber device 102 to perform the communication using the carrier channel RF1 202. As noted, the use of some margin can be utilized to ensure that the cyclic prefix is at least long enough to accommodate the delay spread that is likely to exist during a window of time. This addresses situations of a mobile station where the movement of the subscriber device 102 is likely to cause a varying link impairment and avoids the situation where a length of cyclic prefix is utilized that is inadequate to the task of maximizing the likelihood of received signal information recovery.

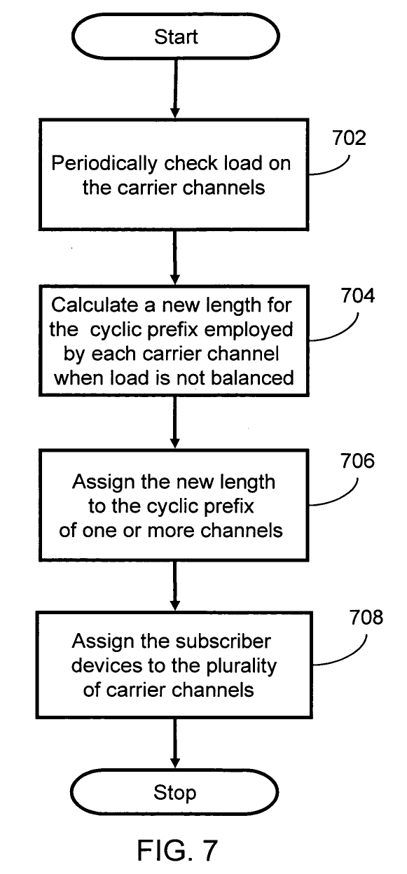

FIG. 7 is an exemplary flowchart illustrating a method for balancing the load on the carrier channels, in accordance with some embodiments of the present invention. At step 702, the BTS 104 periodically checks the load on the plurality of carrier channels. The load on a carrier channel refers to the number of transmissions being performed using the carrier channel. The load is checked by the checking module 306 mentioned earlier. In one embodiment of the present invention, the BTS 104 periodically checks the load on a predetermined set of carrier channels of the plurality of carrier channels. If the BTS 104 determines that the number of transmissions on all the carrier channels that are checked is equal, or reasonably close to one another, or within a predefined range, then the load is balanced. If the BTS 104 finds that the load on the carrier channels is balanced, there is no change in the channel assignment.

However, if the BTS 104 finds that the load on the carrier channels is unbalanced, then, at step 704, the BTS 104 calculates new lengths of the cyclic prefixes employed by the carrier channels, based on the link impairments of the subscriber devices using the carrier channels. In one embodiment of the present invention, the BTS 104 calculates the new lengths of the cyclic prefixes employed by all the carrier channels. In another embodiment of the present invention, the BTS 104 calculates the new lengths of the cyclic prefixes employed by only those carrier channels that are not fully occupied. The new, lengths of the cyclic prefixes are determined to more evenly balance the loading of the carrier channels, while at the same time improving the throughput on the channels by assigning the carrier channels to subscriber devices in a manner that allows for substantial matching of the link impairments of the subscriber devices to delay spreads of the carrier channels, with the delay spread of a carrier channel being longer than the delay spread indicated by the link impairments of the subscriber devices assigned thereto. At step 706, the BTS 104 assigns the new lengths to the cyclic prefixes employed by the corresponding carrier channels. At step 708, the BTS 104 assigns the subscriber devices to the carrier channels, based on the new cyclic prefixes employed by the carrier channels. Subscriber devices are then assigned to the plurality of carrier channels, based on the link impairments associated with the subscriber devices.

It should be noted that any change to the length of cyclic prefixes used by the carrier channels must be made subsequent to informing any of the subscriber devices whose transmissions have been assigned to those carrier channels. For proper reception, it is necessary that a receiving device knows the encoding of the information that is being received. This includes the length of the cyclic prefix, and also the coding of the other information in the transmission. For example, if a shorter cyclic prefix is utilized, more information may be included in the remainder of the OFDM transmission bursts. It is necessary for the receiving device to know how each transmission—with each possible cyclic prefix that might be assigned—is coded. So, when a change of the cyclic prefix for a particular carrier channel is about to be made, each user of that carrier channel is signaled how to make its transmissions. This might be simply to use the same carrier channel and to utilize transmission coding associated with a shorter or longer cyclic prefix. It may alternatively be to change the carrier channel. In any case, such signaling messages might typically include an indication of exactly when to make the transition to the new transmission information coding, or to a different carrier channel, or both. In this way, seamless sequential channel resource transitions are made possible.

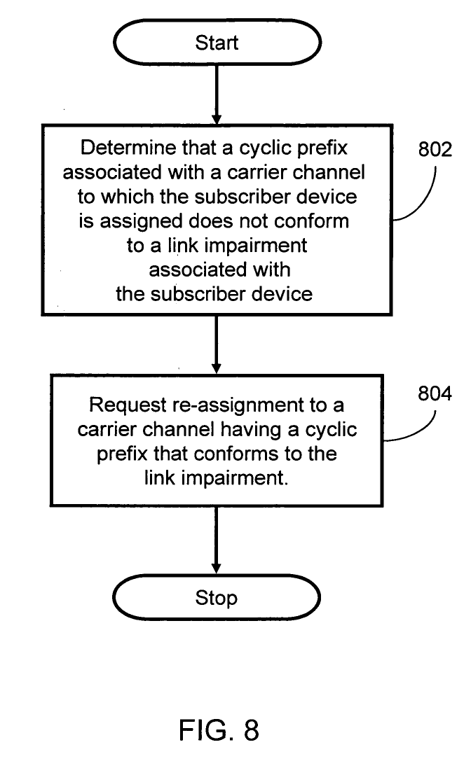

FIG. 8 is an exemplary flowchart illustrating a method for the subscriber device, to make a request for a new carrier channel, in accordance with some embodiments of the present invention. At step 802, the subscriber device 102 determines that the cyclic prefix associated with the carrier channel to which the transmission of the subscriber device 102 is assigned does not conform to the link impairment associated with the subscriber device 102. At step 804, the subscriber device 102 requests the BTS 104 to re-assign it to a carrier channel employing the cyclic prefix that conforms to the link impairment associated with the subscriber device 102. In one embodiment of the present invention, the subscriber device 102 includes a hardware component that is capable of determining the delay spread characteristic of the subscriber device 102. In this case, also, the subscriber device 102 is making decisions about which carrier channels it should be assigned to. Alternatively, it could have simply provided the BTS 104 via a signaling message, of the determined delay spread characteristic and left the channel assignment decision entirely up to the BTS 104. In the former case, for the subscriber device 102 to be able to make the decision of which carrier channel it should be assigned, it needs to know how the system is using its carrier channels. This list of information could similarly be signaled to the subscriber device 102 on an ongoing basis.

The present invention allows the system to minimize the cyclic prefix durations, for use on each carrier channel of the system, to approximately only that amount that is necessary to accommodate the subscribers served. By doing so, the present invention increases the capacity of the system for useful information communication. This is done without causing performance degradation. The present invention employs multiple cyclic prefixes on different carrier channels, and assigns subscriber devices appropriately. The subscriber devices are actively managed and appropriately assigned to the carrier channels, each of which employs a particular cyclic prefix length. Further, the subscriber traffic population amongst a plurality of carrier channels is managed across OFDM carrier channels employing different cyclic prefixes. Moreover, the means to dynamically manage the actual length of cyclic prefix used for each carrier channel is identified by balancing the subscriber load across the carriers and optimizing the particular selection of cyclic prefix lengths utilized.

Subscriber devices are actively signaled with updating and control information, for example, information as to which carrier channel they should be using, when they should move to another carrier channel, etc.

It will be appreciated the modules described herein may be comprised of one or more conventional processors and unique stored program instructions that control the one or more processors to implement, in conjunction with certain non-processor circuits, some, most, or all of the functions of the modules described herein. The non-processor circuits may include, but are not limited to, a radio receiver, a radio transmitter, signal drivers, clock circuits, power source circuits, and user input devices. As such, these functions may be interpreted as steps of a method to perform {accessing of a communication system}. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method used for channel assignment of a subscriber device in an Orthogonal Frequency Division Multiplexed (OFDM) system, the OFDM system comprising a plurality of carrier channels, the method comprising:
estimating a link impairment associated with the subscriber device; and
assigning the subscriber device to a carrier channel of the plurality of carrier channels that employs a cyclic prefix that conforms to the link impairment.

2. The method according to claim 1, further comprising determining at least one link parameter, wherein the estimating of the link impairment is based on the at least one link parameter.

3. The method according to claim 2, wherein one of the at least one link parameters is a delay spread that is measured from one or more signals transmitted or received by the subscriber device.

4. The method according to claim 1, wherein assigning the subscriber device to the carrier channel comprises comparing the link impairment with a set of cyclic prefixes, wherein the set of cyclic prefixes includes each cyclic prefix employed by one or more of the plurality of carrier channels.

5. The method according to claim 3, wherein assigning the subscriber device to the carrier channel comprises selecting a carrier channel employing a cyclic prefix from a set of cyclic prefixes, wherein the cyclic prefix employed by the carrier channel has a shortest length of the set of cyclic prefixes associated with the carrier channels that exceeds the link impairment associated with the subscriber device.

6. The method according to claim 5, wherein the subscriber device generating the one or more transmissions is capable of selecting the carrier channel.

7. The method according to claim 2, wherein one of the at least one link parameters is a distance of the subscriber device from a transmitter of the system.

8. The method according to claim 7, wherein the distance of the subscriber device from the transmitter is determined by the strength of a signal transmitted by the transmitter and received by the subscriber device.

9. The method according to claim 1, further comprising initially assigning the subscriber device to a first carrier channel from amongst the plurality of carrier channels, wherein length of the cyclic prefix employed by the first carrier channel is maximum.

10. The method according to claim 1, wherein determining one of the at least one link parameters comprises repetitively measuring values from which the one of the at least one link parameter is determined.

11. The method according to claim 1, further comprising periodically checking a load on one or more of the plurality of carrier channels.

12. The method according to claim 11, further comprising:
calculating a new length for the cyclic prefix employed by at least one carrier channel from amongst the plurality of carrier channels when the load is not balanced;
assigning the new length to the cyclic prefix employed by the at least one carrier channel from amongst the plurality of carrier channels; and
assigning the subscriber device to one of the plurality of carrier channels based on the link impairment associated with the subscriber device.

13. A method used in a subscriber device that operates in a system employing an Orthogonal Frequency Division Multiplexing (OFDM) system, the OFDM system comprising a plurality of carrier channels, each carrier channel from amongst the plurality of carrier channels employing transmissions that include a cyclic prefix associated with the carrier channel, the method comprising:
determining that a cyclic prefix associated with a carrier channel of the plurality of carrier channels to which the subscriber device is assigned does not conform to a link impairment associated with the subscriber device; and
requesting re-assignment to a carrier channel employing a cyclic prefix that conforms to the link impairment.

14. The method according to claim 13, further comprising the subscriber device assigning the subscriber device to the carrier channel that employs the cyclic prefix that conforms to the link impairment.

15. A system used for channel assignment of a subscriber device in an Orthogonal Frequency Division Multiplexing (OFDM) system, the OFDM system comprising a plurality of carrier channels, each carrier channel employing transmissions that include a cyclic prefix associated with the carrier channel, the system comprising:
a monitoring module capable of estimating a link impairment associated with the subscriber device; and
an assignment module capable of assigning a subscriber device to a carrier channel that employs a cyclic prefix that conforms to the link impairment.

16. The system according to claim 15, wherein the monitoring module comprises:
a collector capable of determining one or more link parameters associated with a channel used by the subscriber device;
a calculator capable of estimating the link impairment from the one or more link parameters.

17. The system according to claim 16, wherein the one or more link parameters comprise at least one link parameter from a set of link parameters consisting of a measured delay spread, a distance, and a type of environment.

18. The system according to claim 15, wherein the assignment module comprises:
a comparator capable of comparing a duration of the link impairment with a duration of each of a set of cyclic prefixes, wherein the set of cyclic prefixes includes each cyclic prefix employed by a set of carrier channels that includes at least two of the plurality of carrier channels; and
a selector capable of selecting a carrier channel employing a cyclic prefix from the set of cyclic prefixes, wherein the cyclic prefix employed by the carrier channel has a minimum length corresponding to the link impairment.

19. The system according to claim 15, further comprising a checking module capable of periodically checking a load on the plurality of carrier channels.

20. The system according to claim 15, further comprising a cyclic prefix calculator capable of calculating a length of the cyclic prefix employed by each carrier channel from amongst the plurality of carrier channels.
